(19) United States
(12) Patent Application Publication
(10) Pub. No.: US 2024/0019053 A1
(43) Pub. Date: Jan. 18, 2024

(54) KNIFE-EDGE FLANGE JOINT ASSEMBLIES

(71) Applicant: Rockwell Collins, Inc., Cedar Rapids, IA (US)

(72) Inventors: Mark A. Schoelen, Dallas, TX (US); Conan S. St. John, Allen, TX (US); David Lewis, Dallas, TX (US)

(73) Assignee: Rockwell Collins, Inc., Cedar Rapids, IA (US)

(21) Appl. No.: 18/209,826

(22) Filed: Jun. 14, 2023

Related U.S. Application Data
(60) Provisional application No. 63/352,295, filed on Jun. 15, 2022.

(51) Int. Cl. F16L 19/02; F16L 19/025

(52) U.S. Cl. CPC F16L 19/0218; F16L 19/025

(57) ABSTRACT

An assembly includes a first tube including a first flange at one end, wherein the first flange includes a first knife-edge ring defined in an axial face thereof. A second tube includes a second flange at one end, wherein the second flange includes a second knife-edge ring defined in an axial face thereof. A gasket is seated between the first and second flanges. The gasket is in a deformed state conforming to the first and second knife-edge rings to seal a space inside the first and second tubes from an external environment. A nut is included radially outward from the first and second flanges, wherein the nut includes internal threads engaged to compress the first and second flanges toward one another.

### CROSS REFERENCE TO RELATED APPLICATIONS

This application claims priority to and the benefit of U.S. Provisional Patent Application No. 63/352,295 filed on Jun. 15, 2022, the entire content of which is herein incorporated by reference.

### STATEMENT REGARDING FEDERALLY SPONSORED RESEARCH OR DEVELOPMENT

This invention was made with government support under Contract No. N00019-14-G-0021 awarded by the U.S. Department of the Navy. The U.S. government has certain rights in the invention.

### BACKGROUND

### 1. Field

The present disclosure relates to sealing interfaces, and more particularly to seals where knife-edge flanges are used to press into and deform a sealing gasket.

### 2. Description of Related Art

Demountable gas-tight knife-edge flange joints per International Organization for Standardization (ISO) 3669 are secured using a fastener array to compress and deform the gasket, creating a very low leak rate seal against vacuum or positive pressure. These interchangeable joint types are ubiquitous in industry and widely commercially available. Unfortunately, for some applications ISO 3669 joints too are heavy, too cumbersome to assemble, and are not space efficient enough.

The conventional techniques have been considered satisfactory for their intended purpose. However, there is an ever present need for improved systems and methods for improved knife-edge flange joints. This disclosure provides a solution for this need.

### SUMMARY

An assembly includes a first tube including a first flange at one end, wherein the first flange includes a first knife-edge ring defined in an axial face thereof. A second tube includes a second flange at one end, wherein the second flange includes a second knife-edge ring defined in an axial face thereof. A gasket is seated between the first and second flanges. The gasket is in a deformed state conforming to the first and second knife-edge rings to seal a space inside the first and second tubes from an external environment. A nut is included radially outward from the first and second flanges, wherein the nut includes internal threads engaged to compress the first and second flanges toward one another.

The nut can include recesses configured for hook spanner engagement. The nut can include preload locking threads. The gasket can include at least one of a compliant metal or an elastomeric material.

The first flange can includes external threads, wherein the internal threads of the nut are threaded to the external threads of the first flange. The second flange can be captured between the first flange and an inward rim of the nut. The first flange can include axially facing recesses configured for face spanner engagement.

The nut can include at least one leak-check port defined therethrough in a radial direction. At least one of the first and second flanges can include at least one leak-check groove defined therein extending from a gasket pocket in the axial face thereof. The at least one leak-check port and the at least one leak-check groove can be in fluid communication with one another radially outward from the gasket for detection of leakage through the gasket by an external detector. The number of leak check ports can be unequal to the number of leak check grooves to facilitate leak detection.

A first backing ring can be assembled over the first flange. A second backing ring can be assembled over the second flange. A threaded ring with external threads can be threaded into the internal threads of the nut. The first and second backing rings can be captured axially between the nut and the threaded ring. The first and second flanges can be captured axially between the first and second backing rings.

The first flange can have an outer diameter that is smaller than an inner diameter of the thread ring so the threaded ring can be assembled over the first flange. The second flange can have an outer diameter that is smaller than an inner diameter of the nut so the nut can be assembled over the second flange.

Each of the first and second backing rings can be circumferentially segmented into a plurality of segments configured to be assembled onto and off of the first and second flanges, respectively, radially. The segments of each of the first and second backing rings can be hinged together. The first and second backing rings can be captured between an inward rim of the nut and an inward rim of the threaded ring. The threaded ring can include axially facing recesses configured for face spanner engagement.

The nut can include at least one leak-check port defined therethrough in a radial direction. At least one of the first and second backing rings can include at least one leak-check groove defined therein extending from a gasket pocket housing the gasket. The at least one leak-check port and the at least one leak-check groove can be in fluid communication with one another radially outward from the gasket for detection of leakage through the gasket by an external detector. The number of leak check ports can be unequal to the number of leak check grooves to facilitate leak detection.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is an exploded cross-sectional perspective view of an embodiment of an assembly constructed in accordance with the present disclosure, showing the nut with its internal threads, and the first flange with its external threads;

FIG. 2 is an exploded perspective view of the assembly of FIG. 1, showing the spanner recesses in the first flange and nut;

FIG. 3 is a cross-sectional perspective view of a portion of the assembly of FIG. 1, showing the engagement of the nut and first flange to confine the gasket between the knife-edge rings of the flanges;

FIG. 4 is an exploded perspective view of another assembly constructed in accordance with this disclosure, showing the backing rings; and

FIG. 5 is a cross-sectional perspective view of a portion of the assembly of FIG. 4, showing the engagement of the nut and threaded ring to confine the gasket between the knife-edge rings of the flanges.

### DETAILED DESCRIPTION OF THE PREFERRED EMBODIMENTS

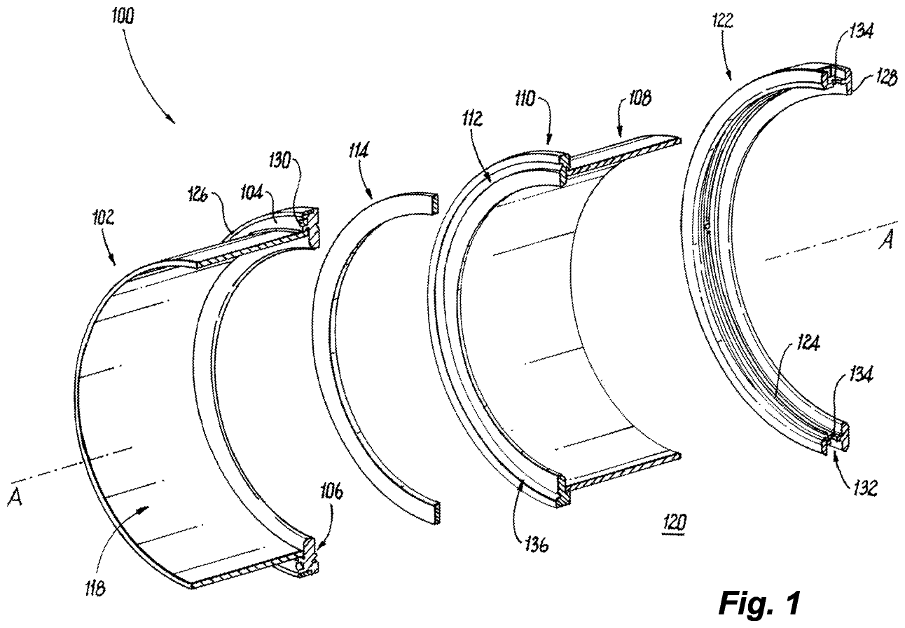

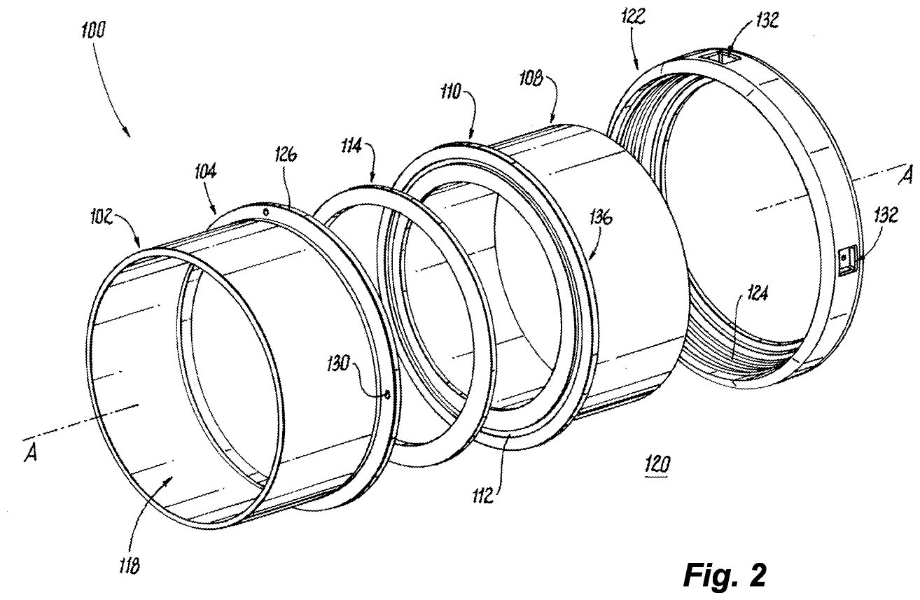

Reference will now be made to the drawings wherein like reference numerals identify similar structural features or aspects of the subject disclosure. For purposes of explanation and illustration, and not limitation, a partial view of an embodiment of an assembly in accordance with the disclosure is shown in FIG. 1 and is designated generally by reference character 100. Other embodiments of systems in accordance with the disclosure, or aspects thereof, are provided in FIGS. 2-5, as will be described. The systems and methods described herein can be used to provide for improved knife-edge flange joints relative to standard knife-edge flange joints.

The assembly 100 includes a first tube 102 defining an axis A and including a first flange 104 at one end, wherein the first flange 104 includes a first knife-edge ring 106 defined in an axial face thereof. As shown in FIG. 2, a second tube 108 includes a second flange 110 at one end, wherein the second flange 110 includes a second knife-edge ring 112 defined in an axial face thereof. The flanges 104, 110 can be integral with or joined, e.g. welded, to their respective tubes 102, 108.

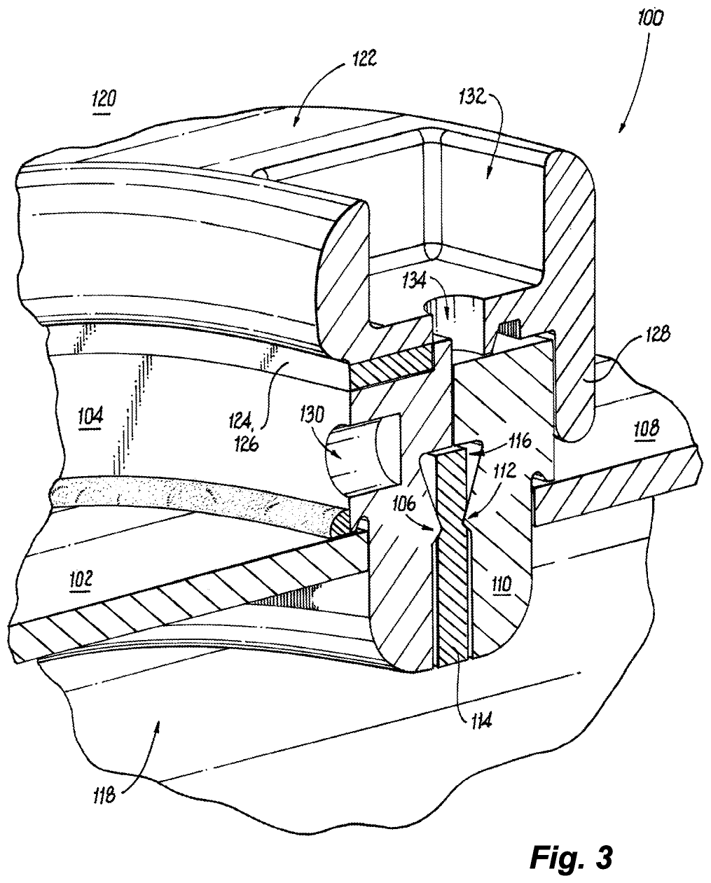

As shown in FIG. 3, a gasket 114 is seated between the first and second flanges 104, 110. The gasket 114 includes at least one of a compliant metal such as Indium or its alloys or similar metal or an elastomeric material. During assembly, the gasket 114 is pressed by the knife-edge rings 106, 112 into a deformed state conforming to the first and second knife-edge rings 106, 112. The gasket is confined in a pocket 116 during its deformation and seals a space 118 inside the first and second tubes from an external environment 120. This can allow the space 118 to be at a vacuum (lower pressure than the external environment 120) or to be pressurized with a higher pressure than the external environment 120. With reference to all of FIGS. 1-3, a nut 122 is included radially outward from the first and second flanges 104, 110. The nut includes internal threads 124 shown schematically in FIG. 3, but see also FIGS. 1 and 2.

The internal threads 124 are engaged to compress the first and second flanges 104, 110 toward one another, compressing the gasket 114 between the flanges 104, 110. The first flange 104 includes external threads 126, wherein the internal threads 124 of the nut are threaded to the external threads 126 of the first flange. As shown in FIG. 3, the second flange 110 is captured axially between the first flange 104 and an inward rim 128 of the nut 122.

The first flange 104 includes axially facing recesses 130 configured for face spanner engagement, i.e. a face spanner can engage the recesses 130 in an axial approach for gripping the flange 104 for tightening of the threads 124, 126. The nut 122 includes radial facing recesses 132 configured for hook spanner engagement, i.e. a hook spanner can engage the recesses 132 (labeled in FIGS. 2 and 3) from a radial direction to and the hook spanner can be rotated about the axis A (labeled in FIGS. 1 and 2) against the direction of the face spanner engaged to recesses 130 for tightening or loosening of the threads 124, 126. The threads 124, 126 of the nut 122 and/or of the first flange 104 can include preload locking threads to provide an inherent locking mechanism, provided that sufficient joint compression remains after accounting for prevailing torque losses.

The nut 122 includes at least one leak-check port 134 (labeled in FIGS. 1 and 3) defined therethrough in a radial direction. At least one of the first and second flanges 104, 110 includes at least one leak-check groove 136 (labeled in FIGS. 1 and 2) defined therein extending from the gasket pocket 116 (labeled in FIG. 3) in the axial face thereof. The at least one leak-check port 134 (labeled in FIGS. 1 and 3) and the at least one leak-check groove 136 (labeled in FIGS. 1 and 2) are in fluid communication with one another radially outward from the gasket 114 for detection of leakage across the gasket by an external detector such as a mass spectrometer. The number of leak check ports 134 is unequal to the number of leak check grooves 136 such that wherever the tightening of the threads 124, 126 ends, at least one port 134 will be circumferentially proximate to at least one groove 136 to facilitate detection of leaks through the gasket 114.

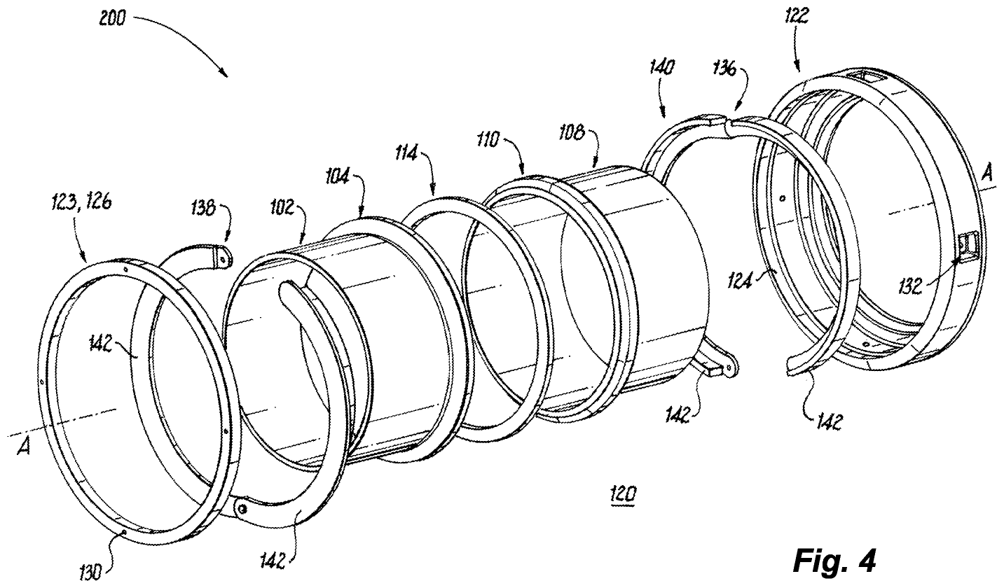

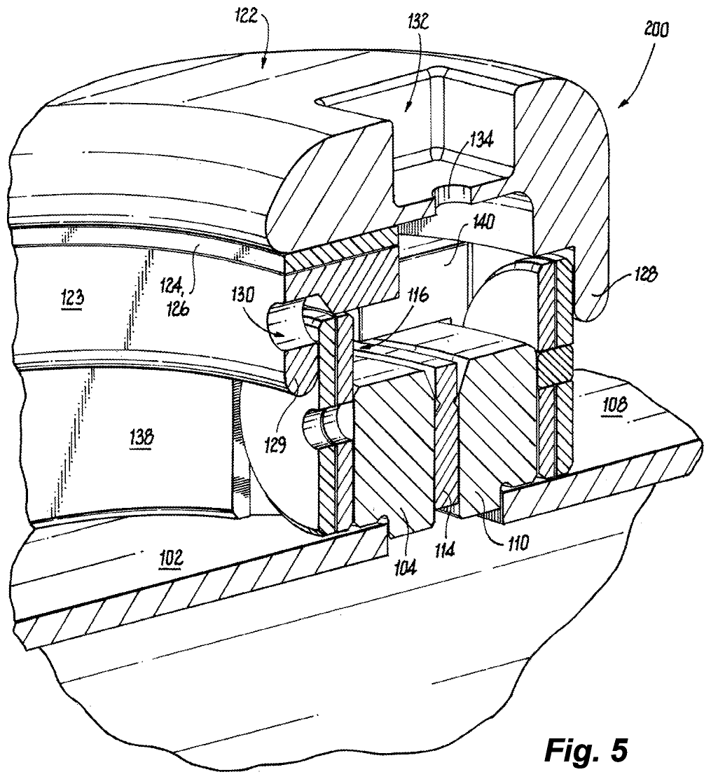

With reference now to FIGS. 4-5, an assembly 200 is provided for cases where fixtures at the ends of tubes 102, 108 opposite their flanges 104, 110 are too large to admit the nut 122 into position. The tubes 102, 108, flanges 104, 110, and gasket 114 are generally similar to those described above with respect to FIGS. 1-3, except that the flange 104 does not need to include outward threads 126 or recesses 130, and the flanges 104, 110 do not need to include grooves 136.

To form the assembly 200 shown in FIG. 5 from the parts shown in FIG. 4, the nut 122 is loosely assembled over the second flange 110 the tube 108, which is possible because the inner most diameter of the nut 122 is larger than the outer most diameter of the flange 110. A threaded ring 123 is similarly assembled loosely over the flange 104 onto the tube 102, which is possible because the inner most diameter of the threaded ring 123 is larger than the outer most diameter of the first flange 104.

A first backing ring 138 is assembled over the first flange 104. A second backing ring 140 is assembled over the second flange 110. Each of the first and second backing rings 138, 140 is circumferentially segmented into a plurality of segments 142 configured to be assembled in a radial direction onto and off of the first and second flanges 104, 110, respectively. The segments 142 of each of the first and second backing rings 138, 140 can optionally be hinged together, and the open ends of the respective segments 142 can optionally be pinned together after assembling onto the flanges 104, 110.

As shown in FIG. 5, the threaded ring 123 includes the external threads 126, which are threaded into the internal threads 124 of the nut 122. The first and second backing rings 138, 140 are captured axially between an inward rim 128 of the nut 122 and an inward rim 129 of the threaded ring 123 as the threads 124, 126 are tightened using spanners engaged in the recesses 130, 132 as described above with respect to FIGS. 1-3. The threaded ring 123 includes the axially facing recesses 130 for face spanner engagement as described above with reference to FIGS. 1-3. This captures the first and second flanges 104, 110 axially between the first and second backing rings 138, 140 to hold the gasket 114 in the compressed state much as described above with respect to FIGS. 1-3.

As labeled in FIG. 5, the nut 122 includes at least one leak-check port 134 defined therethrough in a radial direction. As labeled in FIG. 4, at least one of the first and second backing rings 138, 140 includes at least one leak-check groove 136 defined therein extending from a gasket pocket 116 housing the gasket 114, i.e. the pocket 116 in FIG. 5 is bounded by the flanges 104, 110, the backing rings 138 and 140, and the gasket 114. The at least one leak-check port 134 (labeled in FIG. 5) and the at least one leak-check groove 136 (labeled in FIG. 4) are in fluid communication with one another radially outward from the gasket 114 for detection of leakage across the gasket 114 by an external detector as described above with respect to FIGS. 1-3. The number of leak check ports 134 is unequal to the number of leak check grooves 136 as described above.

Potential benefits of systems and methods as disclosed herein include the following. A single fastener, the nut 122 and optionally its threaded ring 123 can be sufficient to close the joint and compress the gasket 114. The use of a single fastener combination can markedly improve upon the joint assembly and disassembly time compared to the traditional standard ISO arrangement, which can have anywhere from six to thirty-two fasteners for the standard flange sizes. The single fastener combination can automatically provide for simultaneous uniform clamping across the joint while tightening, whereas the tightening sequence of the fastener array in the standard arrangement must be closely monitored and torque incrementally applied in small steps at each fastener in order to ensure uniform joint closure and sealing. Utilizing a single fastener combination can also facilitate both a reduction of the space required to comprise the joint as well as the commensurate weight of the entire structure compared to the standard arrangement. The single fastener combination can eliminate undesirable exposed sharp edges representing electric field concentrations and physical catch points which are present at the fastener heads, nut elements, and exposed threads of each fastener in the standard arrangement.

The methods and systems of the present disclosure, as described above and shown in the drawings, provide for improved knife-edge flange joints relative to standard knife-edge flange joints. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. An assembly comprising:
a first tube including a first flange at one end, wherein the first flange includes a first knife-edge ring defined in an axial face thereof;
a second tube including a second flange at one end, wherein the second flange includes a second knife-edge ring defined in an axial face thereof;
a gasket seated between the first and second flanges, wherein the gasket is in a deformed state conforming to the first and second knife-edge rings to seal a space inside the first and second tubes from an external environment; and
a nut radially outward from the first and second flanges, wherein the nut includes internal threads engaged to compress the first and second flanges toward one another.

2. The assembly as recited in claim 1, wherein the nut includes recesses configured for hook spanner engagement.

3. The assembly as recited in claim 1, wherein the first flange includes external threads, wherein the internal threads of the nut are threaded to the external threads of the first flange, and wherein the second flange is captured between the first flange and an inward rim of the nut.

4. The assembly as recited in claim 3, wherein the first flange includes axially facing recesses configured for face spanner engagement.

5. The assembly as recited in claim 3, wherein the nut includes at least one leak-check port defined therethrough in a radial direction, and wherein at least one of the first and second flanges includes at least one leak-check groove defined therein extending from a gasket pocket in the axial face thereof, wherein the at least one leak-check port and the at least one leak-check groove are in fluid communication with one another radially outward from the gasket for detection of leakage through the gasket by an external detector.

6. The assembly as recited in claim 5, wherein the at least one leak-check port includes a number of leak check ports greater than zero, wherein the at least one leak-check groove includes a number of leak check grooves greater than zero, wherein the number of leak check ports is unequal to the number of leak check grooves to facilitate leak detection.

7. The assembly as recited in claim 1, further comprising:
a first backing ring assembled over the first flange;
a second backing ring assembled over the second flange; and
a threaded ring with external threads threaded into the internal threads of the nut, wherein the first and second backing rings are captured axially between the nut and the threaded ring, and wherein the first and second flanges are captured axially between the first and second backing rings.

8. The assembly as recited in claim 7, wherein the first flange has an outer diameter that is smaller than an inner diameter of the threaded ring so the threaded ring can be assembled over the first flange, and wherein the second flange has an outer diameter that is smaller than an inner diameter of the nut so the nut can be assembled over the second flange.

9. The assembly as recited in claim 7, wherein each of the first and second backing rings is circumferentially segmented into a plurality of segments configured to be assembled onto and off of the first and second flanges, respectively, radially.

10. The assembly as recited in claim 9, wherein the segments of each of the first and second backing rings are hinged together.

11. The assembly as recited in claim 7, wherein the first and second backing rings are captured between an inward rim of the nut and an inward rim of the threaded ring.

12. The assembly as recited in claim 7, wherein the threaded ring includes axially facing recesses configured for face spanner engagement.

13. The assembly as recited in claim 7, wherein the nut includes at least one leak-check port defined therethrough in a radial direction, and wherein at least one of the first and second backing rings includes at least one leak-check groove defined therein extending from a gasket pocket housing the gasket, wherein the at least one leak-check port and the at least one leak-check groove are in fluid communication with one another radially outward from the gasket for detection of leakage through the gasket by an external detector.

14. The assembly as recited in claim 13, wherein the at least one leak-check port includes a number of leak check ports greater than zero, wherein the at least one leak-check groove includes a number of leak check grooves greater than zero, wherein the number of leak check ports is unequal to the number of leak check grooves to facilitate leak detection.

15. The assembly as recited in claim 1, wherein the nut includes preload locking threads, and wherein the gasket includes at least one of a compliant metal or an elastomeric material.
